(19) United States
(12) Patent Application Publication
(10) Pub. No.: US 2021/0187839 A1
(43) Pub. Date: Jun. 24, 2021

(54) THREE-DIMENSIONAL PRINTING

(71) Applicant: HEWLETT-PACKARD DEVELOPMENT COMPANY, L.P., SPRING, TX (US)

(72) Inventors: JESISKA TANDY, SAN DIEGO, CA (US); YI FENG, SAN DIEGO, CA (US); ANDRE GARCIA, SAN DIEGO, CA (US)

(21) Appl. No.: 16/962,752

(22) PCT Filed: Mar. 12, 2018
(86) PCT No.: PCT/US2018/022035

§ 371 Date: Jul. 16, 2020

(51) Int. Cl. B29C 64/165; B33Y 10/00; B33Y 70/10

(52) U.S. Cl. CPC B29C 64/165; B29K 2509/08; B33Y 70/10; B33Y 10/00

(57) ABSTRACT

An example of a build material composition for three-dimensional (3D) printing includes a polymer build material and glass. The polymer build material has a reactivity greater than 5%, and the polymer build material is selected from the group consisting of a polyamide, polybutylene terephthalate, polyethylene terephthalate, polyether block amide elastomers, and combinations thereof.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a diagram illustrating an example of a method of forming a build material composition for 3D printing;

FIG. 2 is a flow diagram illustrating an example of a method for 3D printing;

FIGS. 3A through 3E are schematic and partially cross-sectional cutaway views depicting the formation of a 3D part using an example of the 3D printing method disclosed herein;

FIG. 4 is a simplified isometric and schematic view of an example of a 3D printing system disclosed herein; and

FIG. 5 is a graph showing the ultimate tensile strength, the strain at break, and the Young's Modulus of specimens that were 3D printed with example and comparative example build material compositions, with the ultimate tensile strength (in MPa, left axis), the strain at break ((EaB) in %, left axis), and the Young's Modulus (in MPa, right axis) shown on the y-axes, and the specimens identified by the build material composition used to form the specimens on the x-axis.

### DETAILED DESCRIPTION

Some examples of three-dimensional (3D) printing may utilize a fusing agent (including a radiation absorber) to pattern polymer build material. In these examples, an entire layer of the polymer build material is exposed to radiation, but the patterned region (which, in some instances, is less than the entire layer) of the polymer build material is fused/coalesced and hardened to become a layer of a 3D part. In the patterned region, the fusing agent is capable of at least partially penetrating into voids between the polymer build material particles, and is also capable of spreading onto the exterior surface of the polymeric build material particles. This fusing agent is capable of absorbing radiation and converting the absorbed radiation to thermal energy, which in turn fuses/coalesces the polymer build material that is in contact with the fusing agent. Fusing/coalescing causes the polymer build material to join or blend to form a single entity (i.e., the layer of the 3D part). Fusing/coalescing may involve at least partial thermal merging, melting, binding, and/or some other mechanism that coalesces the polymer build material to form the layer of the 3D part.

Build material for 3D printing may include fillers to modify the properties of the 3D parts to be formed therefrom and/or to reduce the cost of the build material. For example, a build material composition including a polymer build material and glass may be used to print 3D parts with high stiffness and/or an increased heat deflection temperature or heat distortion temperature (as compared to the heat deflection temperature of a 3D part printed using a build material that does not include glass).

Build Material Compositions

Disclosed herein is a build material composition that includes a polymer build material having a reactivity greater than 5%, and glass. Using a polymer build material with a reactivity greater than 5% forms 3D parts with greater ultimate tensile strength than 3D parts formed from a similar build material composition, except that the similar build material composition includes a polymer build material with a lower reactivity.

As used herein, the term “reactivity” refers to a build material's propensity to change over time (e.g., a change in molecular weight (weight average or number average) and/or a change in relative solution viscosity). As such, reactivity may be represented as a percentage (i.e., the value of the change (the value after a time period minus the original value) divided by the original value, multiplied by 100).

Reactivity may be measured in terms of the change in molecular weight or the change in relative solution viscosity. The molecular weight of the polymer build material can be characterized using relative solution viscosity (or “solution viscosity” or “relative viscosity” for brevity) as a proxy for molecular weight. Solution viscosity is determined by combining 0.5 wt % of the polymer build material with 99.5 wt % of m-cresol (also known as 3-methylphenol) and measuring the viscosity of the mixture at room temperature (e.g., 20° C.) compared to the viscosity of pure m-cresol. The viscosity measurements are based on the time it takes for a certain volume of the mixture or liquid to pass through a capillary viscometer under its own weight or gravity. The solution viscosity is defined as a ratio of the time it takes for the mixture (including the polymer build material) to pass through the capillary viscometer to the time it takes for the pure liquid to pass through the capillary viscometer. As the mixture is more viscous than the pure liquid, and a higher viscosity increases the time it takes to pass through the capillary viscometer, the solution viscosity is greater than 1. As an example, the mixture of 0.5 wt % of the polymer build material in 99.5 wt % of the m-cresol may take about 180 seconds to pass through the capillary viscometer, and m-cresol may take about 120 seconds to pass through the capillary viscometer. In this example, the solution viscosity is 1.5 (i.e., 180 seconds divided by 120 seconds). Further details for determining solution viscosity under this measurement protocol are described in International Standard ISO 307, Fifth Edition, 2007-May 2015, incorporated herein by reference in its entirety.

To facilitate the measurement of the change in solution viscosity, the polymer build material may be subjected to an aging process for a predetermined amount of time at a specific temperature profile. For example, the aging process may include exposing the polymer build material to an air environment that has a temperature of about 165° C. for about 20 hours. The air environment of this example aging process may be similar to or slightly harsher than the environment to which the polymer build material may be exposed during 3D printing. The 165° C. temperature of this example aging process may be similar to the temperature(s) to which the polymer build material may be exposed during 3D printing (e.g., a feed build material temperature ranging from about 120° C. to about 140° C., a platform heater temperature ranging from about 145° C. to about 160° C., a build material temperature from heating lamps during printing ranging from about 155° C. to about 165° C., etc.). Moreover, the 20 hour time period of this example aging process may be similar to the time period and/or may be representative of several thermal cycles of the 3D printing process. In other examples, the aging time may be extended to compensate for a printing process temperature that is higher than the aging temperature. As such, the conditions associated with the aging process may, without melting the polymer build material, facilitate the change in molecular weight (and therefore, the change in relative solution viscosity) that the polymer build material may have exhibited as a result of being exposed to 3D printing. It is to be understood that the change that the polymer build material may have exhibited as a result of being exposed to 3D printing may be less than the change resulting from the aging process, depending, in part, on the environment, the temperature, and the time period of the 3D printing process. It is also to be understood that other aging processes may be used (e.g., with a temperature up to 220° C., as long as the temperature used is below the melting temperature of the polymer build material used). It is to be further understood, however, that, as used herein, any reactivity, any change in molecular weight, and any change in relative solution viscosity is in relation to the example aging process described herein (i.e., exposing the polymer build material to an air environment and a temperature of about 165° C. for about 20 hours).

The change in solution viscosity (which correlates to the change in molecular weight) may be determined by measuring the solution viscosity of the polymer build material before and after the aging process, and subtracting the “before” solution viscosity from the “after” solution viscosity. Typically, the solution viscosity of the polymer build material is greater after the aging process than before the aging process, due, in part, to polymerization through reactive end groups of the polymer build material (i.e., due to the reactivity of the polymer build material). For example, the polymer build material may have a solution viscosity or relative viscosity ranging from about 1.5 to about 1.9 before the aging process. After the aging process, the solution viscosity or relative viscosity of the polymer build material may increase by greater than 5%. As such, the reactivity of the polymer build material is greater than 5%.

Polymer build materials with greater reactivity have a greater number of reactive functional groups (as compared to the number of reactive functional groups of polymer build materials with lower reactivity). The presence of these additional reactive functional groups allow the more reactive polymer build materials to form more chemical bonds with the glass during the 3D printing process (as compared to the number of chemical bonds formed with the glass by polymer build materials with lower reactivity during 3D printing). While not being bound to any particular theory, it is believed that these additional chemical bonds may improve the adhesion of the polymer build material to the glass, which results in the greater ultimate tensile strength. The improvement in ultimate tensile strength (due to the increased reactivity of the polymer build material) may be more pronounced in 3D parts printed with the use of a fusing agent than 3D parts formed by other methods (e.g., selective laser sintering (SLS), selective laser melting (SLM), injection molding, etc.). Again while not being bound to any particular theory, it is also believed that this more pronounced improvement may be due to the temperature(s) and time period of the 3D printing process that uses a fusing agent. The temperature of the 3D printing process may be lower and/or the time for 3D printing may be faster than comparative methods (e.g., selective laser sintering (SLS), selective laser melting (SLM), injection molding, etc.), and these parameters may contribute to the improved tensile strength and also improve the efficiency of the process. In an example, a 3D part formed from the build material composition disclosed herein has an ultimate tensile strength greater than or equal to 35 MPa.

In the examples disclosed herein, the build material composition for three-dimensional (3D) printing comprises: a polymer build material having a reactivity greater than 5%, wherein the polymer build material is selected from the group consisting of a polyamide, polybutylene terephthalate, polyethylene terephthalate, polyether block amide elastomers, and combinations thereof; and glass. In some examples, the build material composition may include additional components, such as an antioxidant, a brightener, a charging agent, a flow aid, or a combination thereof. In other examples, the build material composition consists of the polymer build material having a reactivity greater than 5% and the glass.

The polymer build material is selected from the group consisting of a polyamide (PA), polybutylene terephthalate (PBT), polyethylene terephthalate (PET), polyether block amide (PEBA) elastomers, and combinations thereof. Examples of the polyamide build material include PA 12/nylon 12, PA 11/nylon 11, PA 6/nylon 6, and PA 13/nylon 13.

When the polymer build material is PA 12, the greater reactivity of the polymer build material may be due to a greater number of carboxylic and/or amino end groups. An example of a PA 12 that has a reactivity of about 31% is commercially available from Evonik Industries under the tradename VESTOSINT® 1115.

Polyether block amide (PEBA) elastomers may be obtained by the polycondensation of a carboxylic acid polyamide (PA 6, PA 11, PA 12) with an alcohol termination polyether (e.g., polytetramethylene glycol (PTMG), polyethylene glycol (PEG), etc.). Two examples of commercially available PEBA elastomers include those known under the tradename of PEBAX® (Arkema) and VESTAMID® E (Evonik Industries).

As mentioned above, the polymer build material has a reactivity greater than 5%. In an example, the polymer build material has a reactivity greater than or equal to 10%; or greater than or equal to 15%; or greater than or equal to 20%; or greater than or equal to 25%; or greater than or equal to 30%. In another example, the reactivity of the polymer build material ranges from greater than 5% to 40%. In still another example, the reactivity of the polymer build material ranges from 10% to 40%. In yet another example, the reactivity of the polymer build material ranges from 30% to 40%. In yet another example, the reactivity of the polymer build material is about 9.53%. In yet another example, the reactivity of the polymer build material is about 31%.

The polymer build material having such a reactivity enables the build material composition to be used to form 3D parts with increased ultimate tensile strength (as compared to 3D parts formed from a similar build material but that includes a polymer build material with a lower reactivity). As mentioned above, the increased reactivity may enable the increased ultimate tensile strength by enabling the formation of additional chemical bonds between the polymer build material and the glass. In an example, as the reactivity of the polymer build material increases, the ultimate tensile strength of the 3D part formed from the build material composition also increases. In another example, once the reactivity of the polymer build material reaches a threshold (e.g., 40%), the ultimate tensile strength of the 3D part formed from the build material composition may not increase further. This may be due to the complete reaction of the functional groups of the glass and/or insufficient kinetics during the 3D printing process for the formation of additional chemical bonds between the polymer build material and the glass.

In an example, a 3D part formed from the build material composition has an ultimate tensile strength greater than or equal to 35 MPa. In another example (e.g., when the weight ratio of the glass to the polymer build material ranges from about 5:95 to about 40:60), a 3D part formed from the build material composition has an ultimate tensile strength greater than or equal to 40 MPa. The ultimate tensile strength of a 3D part formed from the build material composition may depend, in part, on the glass content of the build material composition and/or the polymer build material used in the build material composition. For example, when the glass content is lower (e.g., 40 wt % or less), the ultimate tensile strength may be higher, e.g., 43 MPa, 45 MPa, or more. In yet another example, a 3D part formed from the build material composition has an ultimate tensile strength that is 25% to 30% greater than the ultimate tensile strength of a comparable 3D part formed from a build material including glass and a polymer build material having a reactivity less than or equal to 5%.

In some examples (e.g., when the glass is dry mixed with the polymer build material), the polymer build material may be in the form of a powder. In other examples, the polymer build material may be in the form of a powder-like material, which includes, for example, short fibers having a length that is greater than its width. In some examples, the powder or powder-like may be formed from, or may include, short fibers that may, for example, have been cut into short lengths from long strands or threads of material.

In some examples, the polymer build material may have a wide processing window of greater than 5° C., which can be defined by the temperature range between the melting point and the re-crystallization temperature. In other examples (e.g., more amorphous polymers), the processing window may be lower than the crystallization temperature. The polymer build material may have a melting point/range or softening point/range ranging from about 130° C. to about 260° C. As an example, the polymer build material may be the polyamide and have a melting point of about 180° C.

The build material composition also includes the glass. In an example, the glass is selected from the group consisting of solid glass beads, hollow glass beads, porous glass beads, glass fibers, crushed glass, and a combination thereof. In another example, the glass is selected from the group consisting of soda lime glass (Na₂O/CaO/SiO₂), borosilicate glass, phosphate glass, fused quartz, and a combination thereof. In still another example, the glass is selected from the group consisting of soda lime glass, borosilicate glass, and a combination thereof. In yet other examples, the glass may be any type of non-crystalline silicate glass.

In some examples, a surface of the glass is modified with a functional group selected from the group consisting of an acrylate functional silane, a methacrylate functional silane, an epoxy functional silane, an ester functional silane, an amino functional silane, and a combination thereof. Examples of glass modified with such functional groups and/or such functional groups that may be used to modify the glass are available from Potters Industries, LLC (e.g., an epoxy functional silane or an amino functional silane), Gelest, Inc. (e.g., an acrylate functional silane or a methacrylate functional silane), Sigma-Aldrich (e.g., an ester functional silane), etc. In an example, the polymer build material is the polyamide, and the surface of the glass is modified with an amino functional silane. In other examples, a surface of the glass is not modified with any functional group.

In a specific example, the glass is selected from the group consisting of soda lime glass, borosilicate glass, phosphate glass, fused quartz, and a combination thereof; or a surface of the glass is modified with a functional group selected from the group consisting of an acrylate functional silane, a methacrylate functional silane, an epoxy functional silane, an ester functional silane, an amino functional silane, and a combination thereof; or a combination thereof.

In some examples, the glass is dry blended with the polymer build material. In other examples, the glass is encapsulated by the polymer build material. When the glass is encapsulated by the polymer build material, the polymer build material may form a continuous coating (i.e., none of the glass is exposed) or a substantially continuous coating (i.e., 5% or less of the glass is exposed) on the glass. Whether the glass is dry blended with the polymer build material or encapsulated by the polymer build material may depend, in part, on i) the characteristics of the glass, and ii) the 3D printer with which the build material composition is to be used. As an example, when the glass includes glass fibers and/or crushed glass, the glass may be encapsulated by the polymer build material. As another example, when segregation of dry blended polymer build material and glass may occur and cause damage to the 3D printer in which the build material composition is to be used, the glass may be encapsulated by the polymer build material.

The polymer build material, the glass, and/or the encapsulated build material (i.e., the glass encapsulated by the polymer build material) may be made up of similarly sized particles or differently sized particles. The term “particle size”, as used herein, refers to the diameter of a spherical particle, or the average diameter of a non-spherical particle (i.e., the average of multiple diameters across the particle), or the volume-weighted mean diameter of a particle distribution. In an example, the average particle size of the build material composition ranges from about 5 μm to about 100 μm. In another example, the average particle size of the build material composition ranges from about 10 μm to about 100 μm.

In some examples, the average particle size(s) of the build material composition may depend on whether the glass is dry blended with the polymer build material or encapsulated by the polymer build material. When the glass is dry blended with the polymer build material, the average particle size of the polymer build material may range from about 20 μm to about 100 μm, and the average particle size of the glass may range from about 5 μm to about 100 μm. In an example, the D50 (i.e., the median of the particle size distribution, where ½ the population is above this value and ½ is below this value) of the polymer build material may be about 60 μm.

When the glass is encapsulated by the polymer build material, the average particle size of the glass (prior to being coated) may range from about 5 μm to about 100 μm. In another example, the average particle size of the glass (prior to being coated) may range from about 30 μm to about 50 μm. The average particle size of the encapsulated build material (i.e., the glass coated with the polymer build material) may depend upon the size of the glass prior to coating and the thickness of the polymer build material that is applied to the glass. In an example, the average particle size of the encapsulated build material may range from about 10 μm to about 200 μm. In another example, the average particle size of the encapsulated build material may range from about 20 μm to about 120 μm. In still another example, the D50 of the encapsulated build material may be about 60 μm.

The weight ratio of the glass to the polymer build material ranges from about 5:95 to about 60:40. In some examples, the weight ratio of the glass to the polymer build material ranges from about 10:90 to about 60:40; or from about 20:80 to about 60:40; or from about 40:60 to about 60:40; or from about 5:95 to about 40:60; or from about 5:95 to about 50:50. In another example, the weight ratio of the glass to the polymer build material is 40:60. In still another example, the weight ratio of the glass to the polymer build material is 50:50. In yet another example, the weight ratio of the glass to the polymer build material is 60:40. In some instances, additives (e.g., antioxidant(s), brightener(s), charging agent(s), flow aid(s), etc.) may be included in the polymer build material. In these instances, the weight of the polymer build material, for the purpose of determining the weight ratio of the glass to the polymer build material, may include the weight of the additives in addition to the weight of the polymer. In other instances, the weight of the polymer build material, for the purpose of determining the weight ratio of the glass to the polymer build material, includes the weight of the polymer alone (whether or not additives are included in the build material composition). The weight ratio of the glass to the polymer build material may depend, in part, on the desired properties of the 3D part to formed, the glass used, the polymer build material used, and/or the additives included in the polymer build material.

In some examples, the build material composition, in addition to the polymer build material and the glass, may include an antioxidant, a brightener, a charging agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymer build material and/or may prevent or slow discoloration (e.g., yellowing) of the polymer build material by preventing or slowing oxidation of the polymer build material. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). In an example, the antioxidant may be included in the build material composition in an amount ranging from about 0.01 wt % to about 5 wt %, based on the total weight of the build material composition.

Brightener(s) may be added to the build material composition to improve visibility. Examples of suitable brighteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), and combinations thereof. In some examples, a stilbene derivative may be used as the brightener. In these examples, the temperature(s) of the 3D printing process may be selected so that the stilbene derivative remains stable (i.e., the 3D printing temperature does not thermally decompose the stilbene derivative). In an example, the brightener may be included in the build material composition in an amount ranging from greater than 0 wt % to about 10 wt %, based on the total weight of the build material composition.

Charging agent(s) may be added to the build material composition to suppress tribo-charging. Examples of suitable charging agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available charging agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the charging agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition or the polymer build material has an average particle size less than 25 μm. The flow aid improves the flowability of the build material composition by reducing the friction, the lateral drag, and the tribocharge buildup (by increasing the particle conductivity). Examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and aluminum oxide. In an example, the flow aid is added in an amount ranging from greater than 0 wt % to less than 5 wt %, based upon the total weight of the build material composition.

Methods for Making the Build Material Compositions

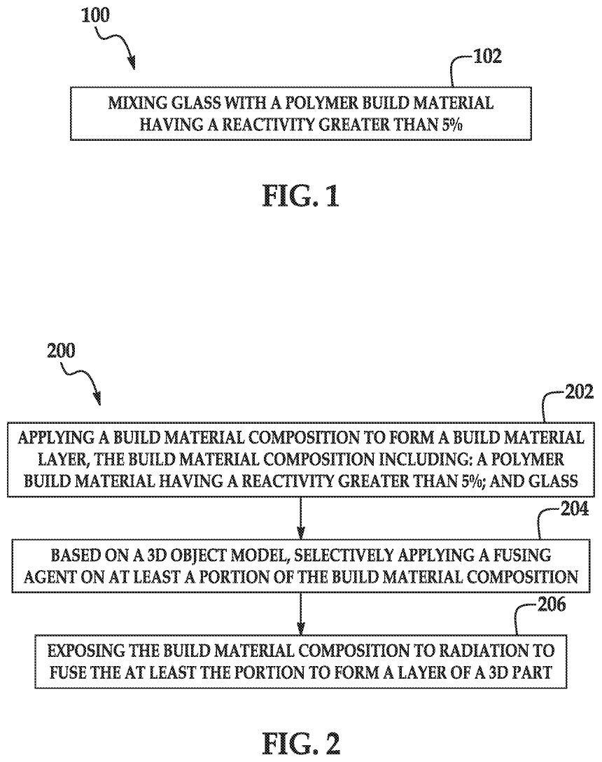

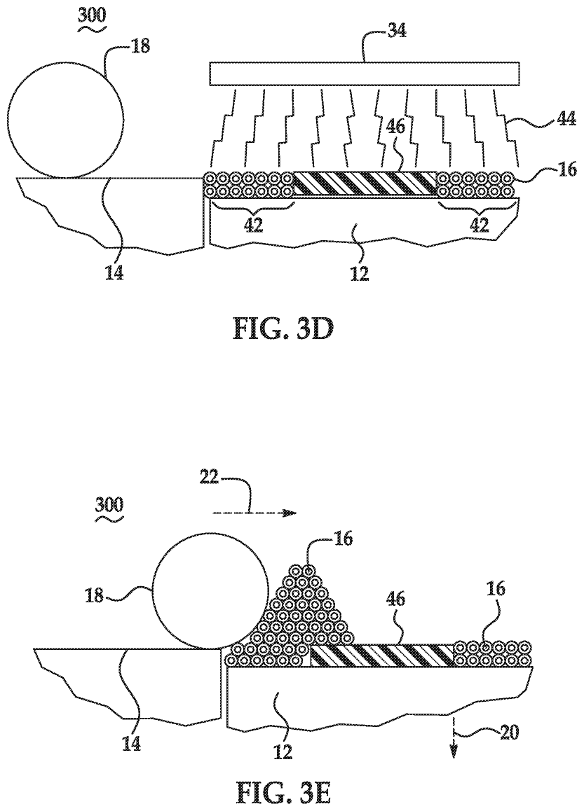

Referring now to FIG. 1, disclosed herein is a method 100 of forming/making an example of the build material composition 16 (see, e.g., FIG. 3A) for 3D printing. The method 100 may be used to form the build material composition 16 when the glass is dry blended with the polymer build material. The method 100 may also be used to form the build material when the glass is encapsulated by the polymer build material.

As shown in FIG. 1, one example of the method 100 comprises: mixing glass with a polymer build material having a reactivity greater than 5% (reference numeral 102). In an example, the amounts of the glass and the polymer build material mixed together are such that a weight ratio of the glass to the polymer build material ranges from about 5:95 to about 60:40.

When glass is blended with the polymer build material, the mixing is a dry blending process. The dry blending may be accomplished by any suitable means. For example, the glass may be dry blended with the polymer build material using a mixer (e.g., an industrial paddle mixer, an industrial high shear mixer, a resonant acoustic mixer, a ball mill, a powder mill, a jet mill, etc.). When the mixer is used to dry blend the glass with the polymer build material, the mixer may be used at a setting that does not break the glass. In some examples (e.g., when a jet mill is used), the mixer may be used for the dry blending and may also be used to reduce the particle size of the polymer build material. In these examples, the polymer build material may have a larger particle size at the beginning of the dry blending process and may have a particle size within the desired range for the polymer build material at the end of the dry blending process.

When the build material composition 16 includes the antioxidant, the brightener, the charging agent, the flow aid, or a combination thereof, the method 100 may include mixing the antioxidant, the brightener, the charging agent, the flow aid, or a combination thereof with the glass and polymer build material, before, after, or during the dry blending. Alternatively, the polymer build material may be obtained (e.g., purchased) with the antioxidant, the brightener, the charging agent, the flow aid, or a combination thereof mixed therein.

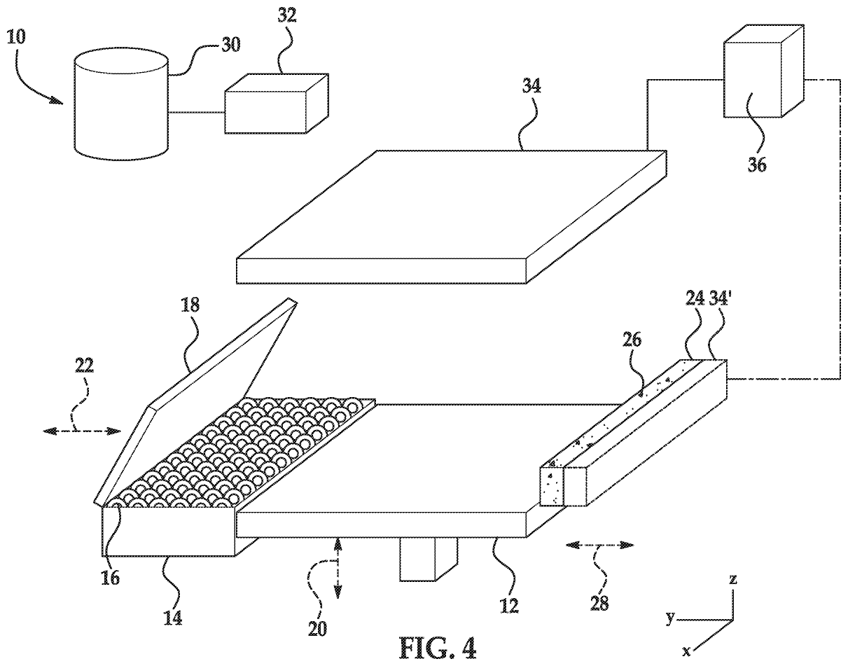

In the examples disclosed herein, it is to be understood that the dry blending may be performed in the printer 10 (see, e.g., FIG. 4), or in a separate powder management station. As examples, dry blending in the printer 10 may take place in the build material supply 14 with suitable mixing hardware (not shown), or in a separate mixing station. In some examples, the separate printing station may be set up to deliver the dry blended build material 16 to the supply and/or platform 12.

Kits for 3D Printing

The build material composition described herein may be part of a 3D printing kit. In an example, the kit for three-dimensional (3D) printing, comprises: a build material composition including: a polymer build material having a reactivity greater than 5%, wherein the polymer build material is selected from the group consisting of a polyamide, polybutylene terephthalate, polyether block amide elastomers, and combinations thereof; and glass; and a fusing agent to be applied to at least a portion of the build material composition during 3D printing, the fusing agent including a radiation absorber to absorb radiation to melt or fuse the polymer build material in the at least the portion. In another example, the kit consists of the build material composition and the fusing agent with no other components. In still another example, the kit further comprises a detailing agent and/or coloring agent. The components of the kit may be maintained separately until used together in examples of the 3D printing method disclosed herein.

As mentioned above, the build material composition includes at least the polymer build material having a reactivity greater than 5% and the glass, and may additionally include the antioxidant, the brightener, the charging agent, the flow aid, or combinations thereof. Any example of the build material composition may be used in the examples of the kit. In one specific example of the kit, a weight ratio of the glass to the polymer build material ranges from about 5:95 to about 60:40.

The fusing agent includes at least the energy absorber. Any of the example compositions of the fusing agent described below may be used in the examples of the kit.

The detailing agent may include a surfactant, a co-solvent, and a balance of water. Any of the example compositions of the detailing agent described below may be used in the examples of the kit.

The coloring agent may include a colorant, a surfactant, a co-solvent, and a balance of water. Any of the example compositions of the coloring agent described below may be used in the examples of the kit.

Printing Methods

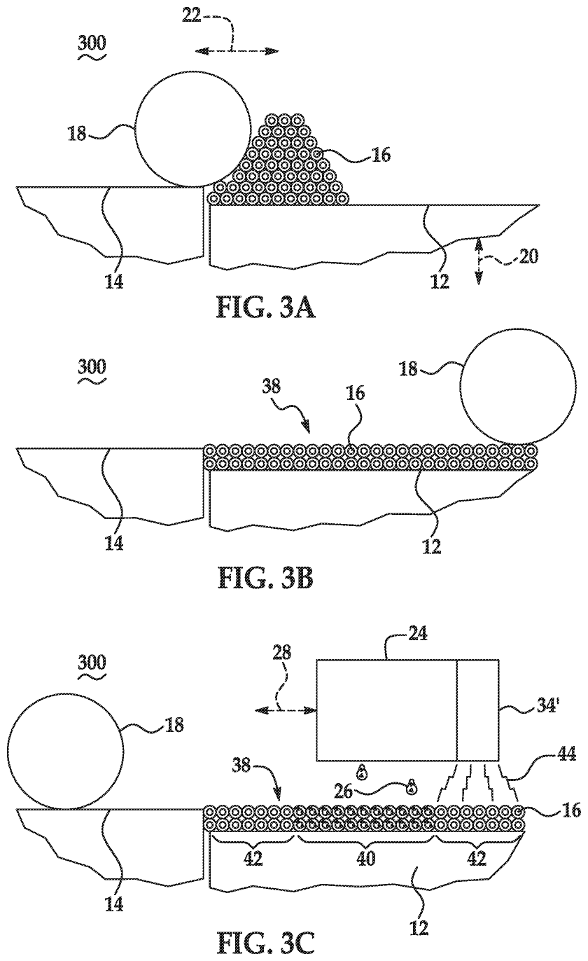

Referring now to FIG. 2 and FIGS. 3A through 3E, an example of a method 200, 300 for 3D printing is depicted. Prior to execution of the method 200, 300 or as part of the method 200, 300, a controller 30 (see, e.g., FIG. 4) may access data stored in a data store 32 (see, e.g., FIG. 4) pertaining to a 3D part that is to be printed. The controller 30 may determine the number of layers of the build material composition 16 that are to be formed and the locations at which the fusing agent 26 from the applicator 24 is to be deposited on each of the respective layers.

Briefly, the method 200 for three-dimensional (3D) printing comprises: applying a build material composition 16 to form a build material layer 38, the build material composition 16 including: a polymer build material having a reactivity greater than 5%; and glass (reference numeral 202); based on a 3D object model, selectively applying a fusing agent 26 on at least a portion 40 of the build material composition 16 (reference numeral 204); and exposing the build material composition 16 to radiation 44 to fuse the at least the portion 40 to form a layer 46 of a 3D part (reference numeral 206).

While not shown, the method 200, 300 may include forming the build material composition 16. In an example, the build material composition 16 is formed prior to applying the build material composition 16. The build material composition 16 may be formed in accordance with the method 100 described above. To briefly reiterate from above, the build material composition 16 may be formed by mixing the glass with the polymer build material. In other examples of the method 200, 300 (e.g., when the glass is encapsulated by the polymer build material), the build material composition 16 may be obtained (e.g., purchased) in the encapsulated form.

As shown at reference numeral 202 in FIG. 2 and in FIGS. 3A and 3B, the method 200, 300, includes applying the build material composition 16 to form the build material layer 38. As mentioned above, the build material composition 16 includes at least the polymer build material having a reactivity greater than 5% and the glass, and may additionally include the additive, the antioxidant, the brightener, the charging agent, the flow aid, or combinations thereof. The build material composition 16 in FIGS. 3A through 3E and FIG. 4 is shown as the encapsulated version of the build material composition 16. However, it is to be understood that the build material composition 16 represents both the encapsulated version and the dry mixed version, and either version of the build material composition 16 may be used in the method 200, 300.

In the example shown in FIGS. 3A and 3B, a printing system (e.g., the printing system 10 shown in FIG. 4) may be used to apply the build material composition 16. The printing system 10 may include a build area platform 12, a build material supply 14 containing the build material composition 16, and a build material distributor 18.

The build area platform 12 receives the build material composition 16 from the build material supply 14. The build area platform 12 may be moved in the directions as denoted by the arrow 20, e.g., along the z-axis, so that the build material composition 16 may be delivered to the build area platform 12 or to a previously formed layer 46. In an example, when the build material composition 16 is to be delivered, the build area platform 12 may be programmed to advance (e.g., downward) enough so that the build material distributor 18 can push the build material composition 16 onto the build area platform 12 to form a substantially uniform layer 38 of the build material composition 16 thereon. The build area platform 12 may also be returned to its original position, for example, when a new part is to be built.

The build material supply 14 may be a container, bed, or other surface that is to position the build material composition 16 between the build material distributor 18 and the build area platform 12.

The build material distributor 18 may be moved in the directions as denoted by the arrow 22, e.g., along the y-axis, over the build material supply 14 and across the build area platform 12 to spread the layer 38 of the build material composition 16 over the build area platform 12. The build material distributor 18 may also be returned to a position adjacent to the build material supply 14 following the spreading of the build material composition 16. The build material distributor 18 may be a blade (e.g., a doctor blade), a roller, a combination of a roller and a blade, and/or any other device capable of spreading the build material composition 16 over the build area platform 12. For instance, the build material distributor 18 may be a counter-rotating roller. In some examples, the build material supply 14 or a portion of the build material supply 14 may translate along with the build material distributor 18 such that build material composition 16 is delivered continuously to the material distributor 18 rather than being supplied from a single location at the side of the printing system 10 as depicted in FIG. 3A.

As shown in FIG. 3A, the build material supply 14 may supply the build material composition 16 into a position so that it is ready to be spread onto the build area platform 12. The build material distributor 18 may spread the supplied build material composition 16 onto the build area platform 12. The controller 30 may process control build material supply data, and in response, control the build material supply 14 to appropriately position the build material particles 16, and may process control spreader data, and in response, control the build material distributor 18 to spread the supplied build material composition 16 over the build area platform 12 to form the layer 38 of build material composition 16 thereon. As shown in FIG. 3B, one build material layer 38 has been formed.

The layer 38 of the build material composition 16 has a substantially uniform thickness across the build area platform 12. In an example, the thickness of the build material layer 38 is about 100 μm. In another example, the thickness of the build material layer 38 ranges from about 30 μm to about 300 μm, although thinner or thicker layers may also be used. For example, the thickness of the build material layer 38 may range from about 20 μm to about 500 μm, or from about 50 μm to about 80 μm. The layer thickness may be about 2× (i.e., 2 times) the particle diameter (as shown in FIG. 3B) at a minimum for finer part definition. In some examples, the layer thickness may be about 1.2× the particle diameter.

After the build material composition 16 has been applied, and prior to further processing, the build material layer 38 may be exposed to heating. Heating may be performed to pre-heat the build material composition 16, and thus the heating temperature may be below the melting point or softening point of the polymer of the build material composition 16. As such, the temperature selected will depend upon the build material composition 16 that is used. As examples, the pre-heating temperature may be from about 5° C. to about 50° C. below the melting point or softening point of the polymer of the build material composition 16. In an example, the pre-heating temperature ranges from about 50° C. to about 250° C. In another example, the pre-heating temperature ranges from about 150° C. to about 170° C.

Pre-heating the layer 38 of the build material composition 16 may be accomplished by using any suitable heat source that exposes all of the build material composition 16 on the build area platform 12 to the heat. Examples of the heat source include a thermal heat source (e.g., a heater (not shown) integrated into the build are platform 12 (which may include sidewalls)) or the radiation source 34, 34′ (see, e.g., FIG. 4).

As shown at reference numeral 204 in FIG. 2 and in FIG. 3C, the method 200, 300 continues by, based on a 3D object model, selectively applying the fusing agent 26 on at least a portion 40 of the build material composition 16. Example compositions of the fusing agent 26 are described below.

It is to be understood that a single fusing agent 26 may be selectively applied on the portion 40, or multiple fusing agents 26 may be selectively applied on the portion 40. As an example, multiple fusing agents 26 may be used to create a multi-colored part. As another example, one fusing agent 26 may be applied to an interior portion of a layer and/or to interior layer(s) of a 3D part, and a second fusing agent 26 may be applied to the exterior portion(s) of the layer and/or to the exterior layer(s) of the 3D part. In the latter example, the color of the second fusing agent 26 will be exhibited at the exterior of the part.

As illustrated in FIG. 3C, the fusing agent 26 may be dispensed from the applicator 24. The applicator 24 may be a thermal inkjet printhead, a piezoelectric printhead, a continuous inkjet printhead, etc., and the selectively applying of the fusing agent 26 may be accomplished by thermal inkjet printing, piezo electric inkjet printing, continuous inkjet printing, etc.

The controller 30 may process data, and in response, control the applicator 24 (e.g., in the directions indicated by the arrow 28) to deposit the fusing agent 26 onto predetermined portion(s) 40 of the build material layer 38 that are to become part of the 3D part. The applicator 24 may be programmed to receive commands from the controller 30 and to deposit the fusing agent 26 according to a pattern of a cross-section for the layer of the 3D part that is to be formed. As used herein, the cross-section of the layer of the 3D part to be formed refers to the cross-section that is parallel to the surface of the build area platform 12. In the example shown in FIG. 3C, the applicator 24 selectively applies the fusing agent 26 on those portion(s) 40 of the build material layer 38 that is/are to become the first layer of the 3D part. As an example, if the 3D part that is to be formed is to be shaped like a cube or cylinder, the fusing agent 26 will be deposited in a square pattern or a circular pattern (from a top view), respectively, on at least a portion of the build material layer 38. In the example shown in FIG. 3C, the fusing agent 26 is deposited on the portion 40 of the build material layer 38 and not on the portions 42.

The volume of the fusing agent 26 that is applied per unit of the build material composition 16 in the patterned portion 40 may be sufficient to absorb and convert enough radiation 44 so that the build material composition 16 in the patterned portion 40 will fuse/coalesce. The volume of the fusing agent 26 that is applied per unit of the build material composition 16 may depend, at least in part, on the radiation absorber used, the radiation absorber loading in the fusing agent 26, and the build material composition 16 used.

As shown at reference numeral 206 in FIG. 2 and FIGS. 3C and 3D, the method 200, 300 continues by exposing the build material composition 16 to radiation 44 to fuse/coalesce the at least the portion 40 to form a layer 46 of a 3D part. The radiation 44 may be applied with the source 34 of radiation 44 as shown in FIG. 3D or with the source 34′ of radiation 44 as shown in FIG. 3C.

The fusing agent 26 enhances the absorption of the radiation 44, converts the absorbed radiation 44 to thermal energy, and promotes the transfer of the thermal heat to the build material composition 16 in contact therewith. In an example, the fusing agent 26 sufficiently elevates the temperature of the build material composition 16 in the layer 38 above the melting or softening point of the polymer of the build material composition 16, allowing fusing/coalescing (e.g., thermal merging, melting, binding, etc.) of the build material composition 16 to take place. The application of the radiation 44 forms the fused layer 46, shown in FIG. 3D. While not shown in FIG. 3D, the fused layer 46 includes the glass particles embedded in the fused polymer build material.

The thermal energy transferred to the build material composition 16 also promotes the formation of chemical bonds between the polymer build material and the glass. The formation of an increased number of these chemical bonds, due to the polymer build material having a reactivity greater than 5% (and therefore, an increased number of reactive functional groups), improves the adhesion of the polymer build material to the glass, which increases the ultimate tensile strength (e.g., to an ultimate tensile strength of 35 MPa, 40 MPa, 45 MPa, or greater) of the 3D printed part.

It is to be understood that portions 42 of the build material layer 38 that do not have the fusing agent 26 applied thereto do not absorb enough radiation 44 to fuse/coalesce. As such, these portions 42 do not become part of the 3D part that is ultimately formed. The build material composition 16 in portions 42 may be reclaimed to be reused as build material in the printing of another 3D part.

In some examples, the method 200, 300 further comprises repeating the applying of the build material composition 16, the selectively applying of the fusing agent 26, and the exposing of the build material composition 16, wherein the repeating forms the 3D part including the layer 46. In these examples, the processes shown in FIG. 2 and FIGS. 3A through 3D may be repeated to iteratively build up several fused layers and to form the 3D printed part.

FIG. 3E illustrates the initial formation of a second build material layer on the previously formed layer 46. In FIG. 3E, following the fusing/coalescing of the predetermined portion(s) 40 of the build material composition 16, the controller 30 may process data, and in response cause the build area platform 12 to be moved a relatively small distance in the direction denoted by the arrow 20. In other words, the build area platform 12 may be lowered to enable the next build material layer to be formed. For example, the build material platform 12 may be lowered a distance that is equivalent to the height of the build material layer 38. In addition, following the lowering of the build area platform 12, the controller 30 may control the build material supply 14 to supply additional build material composition 16 (e.g., through operation of an elevator, an auger, or the like) and the build material distributor 18 to form another build material layer on top of the previously formed layer 46 with the additional build material composition 16. The newly formed build material layer may be in some instances pre-heated, patterned with the fusing agent 26, and then exposed to radiation 44 from the source 34, 34′ of radiation 44 to form the additional fused layer.

Several variations of the previously described method 200, 300 will now be described.

In some examples of the method 200, 300, a detailing agent may be used. The composition of the detailing agent is described below. The detailing agent may be dispensed from another (e.g., a second) applicator (which may be similar to applicator 24) and applied to portion(s) of the build material composition 16.

The detailing agent may provide an evaporative cooling effect to the build material composition 16 to which it is applied. The cooling effect of the detailing agent reduces the temperature of the build material composition 16 containing the detailing agent during energy/radiation exposure. The detailing agent, and its rapid cooling effect, may be used to obtain different levels of melting/fusing/binding within the layer 46 of the 3D part that is being formed. Different levels of melting/fusing/binding may be desirable to control internal stress distribution, warpage, mechanical strength performance, and/or elongation performance of the final 3D part.

In an example of using the detailing agent to obtain different levels of melting/fusing/binding within the layer 46, the fusing agent 26 may be selectively applied according to the pattern of the cross-section for the layer 46 of the 3D part, and the detailing agent may be selectively applied on at least some of that cross-section. As such, some examples of the method 200, 300 further comprise selectively applying, based on the 3D object model, the detailing agent on the at least some of the at least the portion 40 of the build material composition 16. The evaporative cooling provided by the detailing agent may remove energy from the at least some of the portion 40; however, since the fusing agent 26 is present with the detailing agent, fusing is not completely prevented. The level of fusing may be altered due to the evaporative cooling, which may alter the internal stress distribution, warpage, mechanical strength performance, and/or elongation performance of the 3D part. It is to be understood that when the detailing agent is applied within the same portion 40 as the fusing agent 26, the detailing agent may be applied in any desirable pattern. The detailing agent may be applied before, after, or at least substantially simultaneously (e.g., one immediately after the other in a single printing pass, or at the same time) with the fusing agent 26, and then the build material composition 16 is exposed to radiation.

In some examples, the detailing agent may also or alternatively be applied after the layer 46 is fused to control thermal gradients within the layer 46 and/or the final 3D part. In these examples, the thermal gradients may be controlled with the evaporative cooling provided by the detailing agent.

In another example that utilizes the evaporative cooling effect of the detailing agent, the method 200, 300 further comprises selectively applying the detailing agent on another portion 42 of the build material composition 16 to aid in preventing the build material composition 16 in the other portion 42 from fusing. In these examples, the detailing agent is selectively applied, based on the 3D object model, on the other portion(s) 42 of the build material composition 16. The evaporative cooling provided by the detailing agent may remove energy from the other portion 42, which may lower the temperature of the build material composition 16 in the other portion 42 and prevent the build material composition 16 in the other portion 42 from fusing/coalescing.

In some examples of the method 200, 300 a coloring agent may be used. The coloring agent may be selected from the group consisting of a black ink, a cyan ink, a magenta ink, and a yellow ink. The composition of the coloring agent is described below. The coloring agent may be dispensed from another (e.g., a third) applicator (which may be similar to applicator 24) and applied to portion(s) of the build material composition 16.

The coloring agent may color the build material composition 16 to which it is applied. The color of the coloring agent may then be exhibited by the 3D part. The coloring agent may be used to obtain colored or multicolored 3D printed parts.

In an example, the fusing agent 26 may be selectively applied according to the pattern of the cross-section for the layer 46 of the 3D part, and the coloring agent may be selectively applied on at least some of that cross-section. As such, some examples of the method 200, 300 further comprise selectively applying, based on the 3D object model, the coloring agent on the at least some of the at least the portion 40 of the build material composition 16, the coloring agent being selected from the group consisting of a black ink, a cyan ink, a magenta ink, and a yellow ink. The coloring agent may cause the 3D part to exhibit the color (e.g., black, cyan, magenta, yellow, etc.) of the coloring agent. Multiple coloring agents may be used to impart multiple colors to the 3D part. It is to be understood that when the coloring agent(s) is/are applied within the same portion 40 as the fusing agent 26, the coloring agent(s) may be applied in any desirable pattern. The coloring agent may be applied before, after, or at least substantially simultaneously (e.g., one immediately after the other in a single printing pass, or at the same time) with the fusing agent 26, and then the build material composition 16 is exposed to radiation. In other examples, the coloring agent(s) may be applied to the finished 3D part. In these examples, the coloring agent(s) may be used to add color(s) to the exterior of the part.

In some examples, the method 200, 300 further comprises: upon completion of the 3D part, placing the 3D part in an environment having a temperature ranging from about 15° C. to 30° C.; and maintaining the 3D part in the environment until a temperature of the 3D part reaches the temperature of the environment. In these examples, the 3D part is allowed to cool in a room temperature environment (e.g., a temperature ranging from about 15° C. to 30° C.) upon completion of the 3D part (e.g., within about 5 minutes of forming the 3D part). As such, these examples of the method 200, 300 may be faster than examples that include heating the 3D part after its formation (i.e., exposing the 3D part to an aging process).

In other examples, the method 200, 300 further comprises heating the 3D part at a temperature ranging from greater than 30° C. to about 177° C. for a time period ranging from greater than 0 hours to about 144 hours. In an example, the 3D part is heated at a temperature ranging from about 130° C. to about 177° C. In another example, the 3D part is heated at a temperature ranging from about 150° C. to about 177° C. In still another example, the 3D part is heated a temperature ranging from about 165° C. to about 177° C. In yet another example, the 3D part is heated a temperature of about 165° C. In another example, the 3D part is heated for a time period ranging from greater than 0 hours to about 48 hours. In still another example, the 3D part is heated for about 22 hours. The time period for which the 3D part is heated may depend, in part, on the temperature at which the 3D part is heated. For example, when the temperature at which the 3D part is heated is higher (e.g., 165° C.) the time period for which the 3D part is heated may be shorter (e.g., 22 hours). As another example, when the temperature at which the 3D part is heated is lower (e.g., 35° C.) the time period for which the 3D part is heated may be longer (e.g., 140 hours).

Heating may be accomplished by any suitable means. For example, the 3D part may be heated in an oven. Heating the 3D part after its formation may further increase the ultimate tensile strength of the 3D part (as compared to ultimate tensile strength of a 3D part that was allowed to cool in a room temperature environment upon completion of the 3D part).

In an example of the method 200, 300, the 3D part has an ultimate tensile strength greater than or equal to 35 MPa. In another example, the 3D part formed by the method 200, 300 has an ultimate tensile strength greater than or equal to 40 MPa. In any of these examples, the ultimate tensile strength may be achieved whether the method 200, 300 includes allowing the 3D part to cool after formation or the method 200, 300 includes heating the 3D part after formation. In some examples, the 3D part formed by the method 200, 300 has an ultimate tensile strength that is 25% to 30% greater than the ultimate tensile strength of a comparable 3D part formed from a build material including glass and a polymer build material having a reactivity less than or equal to 5%.

Printing System

Referring now to FIG. 4, an example of a 3D printing system 10 is schematically depicted. It is to be understood that the 3D printing system 10 may include additional components (some of which are described herein) and that some of the components described herein may be removed and/or modified. Furthermore, components of the 3D printing system 10 depicted in FIG. 4 may not be drawn to scale and thus, the 3D printing system 10 may have a different size and/or configuration other than as shown therein.

In an example, the three-dimensional (3D) printing system 10, comprises: a supply 14 of a build material composition including a polymer build material having a reactivity greater than 5%; and glass; a build material distributor 18; a supply of a fusing agent 26; an applicator 24 for selectively dispensing the fusing agent 26; a source 34, 34′ of radiation 44; a controller 30; and a non-transitory computer readable medium having stored thereon computer executable instructions to cause the controller 30 to: utilize the build material distributor 18 to dispense the build material composition 16; utilize the applicator 24 to selectively dispense the fusing agent 26 on at least a portion 40 of the build material composition 16; and utilize the source 34, 34′ of radiation 44 to expose the build material composition 16 to radiation 44 to fuse/coalesce the portion 40 of the build material composition 16.

In some examples, the 3D printing system 10 may further include a supply of a detailing agent; a second applicator for selectively dispensing the detailing agent; a supply of a coloring agent; and/or a third applicator for selectively dispensing the coloring agent (none of which are shown). In these examples, the computer executable instructions may further cause the controller 30 to utilize the second applicator to selectively dispense the detailing agent; and/or utilize the third applicator to selectively dispense the coloring agent on at least some of the at least the portion 40.

As shown in FIG. 4, the printing system 10 includes the build area platform 12, the build material supply 14 containing the build material composition 16 including the polymer build material and the glass, and the build material distributor 18.

As mentioned above, the build area platform 12 receives the build material composition 16 from the build material supply 14. The build area platform 12 may be integrated with the printing system 10 or may be a component that is separately insertable into the printing system 10. For example, the build area platform 12 may be a module that is available separately from the printing system 10. The build material platform 12 that is shown is one example, and could be replaced with another support member, such as a platen, a fabrication/print bed, a glass plate, or another build surface.

As also mentioned above, the build material supply 14 may be a container, bed, or other surface that is to position the build material composition 16 between the build material distributor 18 and the build area platform 12. In some examples, the build material supply 14 may include a surface upon which the build material composition 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to provide, e.g., move, the build material composition 16 from a storage location to a position to be spread onto the build area platform 12 or onto a previously formed layer 46 of the 3D part.

As also mentioned above, the build material distributor 18 may be a blade (e.g., a doctor blade), a roller, a combination of a roller and a blade, and/or any other device capable of spreading the build material composition 16 over the build area platform 12 (e.g., a counter-rotating roller).

As shown in FIG. 4, the printing system 10 also includes the applicator 24, which may contain the fusing agent 26. The applicator 24 may be scanned across the build area platform 12 in the directions indicated by the arrow 28, e.g., along the y-axis. The applicator 24 may be, for instance, a thermal inkjet printhead, a piezoelectric printhead, a continuous inkjet printhead, etc., and may extend a width of the build area platform 12. While the applicator 24 is shown in FIG. 4 as a single applicator, it is to be understood that the applicator 24 may include multiple applicators that span the width of the build area platform 12. Additionally, the applicators 24 may be positioned in multiple printbars. The applicator 24 may also be scanned along the x-axis, for instance, in configurations in which the applicator 24 does not span the width of the build area platform 12 to enable the applicator 24 to deposit the fusing agent 26 over a large area of the build material composition 16. The applicator 24 may thus be attached to a moving XY stage or a translational carriage (neither of which is shown) that moves the applicator 24 adjacent to the build area platform 12 in order to deposit the fusing agent 26 in predetermined areas 40 of the build material layer 38 that has been formed on the build area platform 12 in accordance with the method 200, 300 disclosed herein. The applicator 24 may include a plurality of nozzles (not shown) through which the fusing agent 26 is to be ejected.

The applicator 24 may deliver drops of the fusing agent 26 at a resolution ranging from about 300 dots per inch (DPI) to about 1200 DPI. In other examples, the applicator 24 may deliver drops of the fusing agent 26 at a higher or lower resolution. The drop velocity may range from about 5 m/s to about 24 m/s and the firing frequency may range from about 1 kHz to about 100 kHz. In one example, the volume of each drop may be on the order of about 3 picoliters (pl) to about 18 pl, although it is contemplated that a higher or lower drop volume may be used. In some examples, the applicator 24 is able to deliver variable drop volumes of the fusing agent 26. One example of a suitable printhead has 600 DPI resolution and can deliver drop volumes ranging from about 6 pl to about 14 pl.

Each of the previously described physical elements may be operatively connected to a controller 30 of the printing system 10. The controller 30 may process print data that is based on a 3D object model of the 3D object/part to be generated. In response to data processing, the controller 30 may control the operations of the build area platform 12, the build material supply 14, the build material distributor 18, and the applicator 24. As an example, the controller 30 may control actuators (not shown) to control various operations of the 3D printing system 10 components. The controller 30 may be a computing device, a semiconductor-based microprocessor, a central processing unit (CPU), an application specific integrated circuit (ASIC), and/or another hardware device. Although not shown, the controller 30 may be connected to the 3D printing system 10 components via communication lines.

The controller 30 manipulates and transforms data, which may be represented as physical (electronic) quantities within the printer's registers and memories, in order to control the physical elements to create the 3D part. As such, the controller 30 is depicted as being in communication with a data store 32. The data store 32 may include data pertaining to a 3D part to be printed by the 3D printing system 10. The data for the selective delivery of the build material composition 16, the fusing agent 26, etc. may be derived from a model of the 3D part to be formed. For instance, the data may include the locations on each build material layer 38 that the applicator 24 is to deposit the fusing agent 26. In one example, the controller 30 may use the data to control the applicator 24 to selectively apply the fusing agent 26. The data store 32 may also include machine readable instructions (stored on a non-transitory computer readable medium) that are to cause the controller 30 to control the amount of build material composition 16 that is supplied by the build material supply 14, the movement of the build area platform 12, the movement of the build material distributor 18, the movement of the applicator 24, etc.

As shown in FIG. 4, the printing system 10 may also include a source 34, 34′ of radiation 44. In some examples, the source 34 of radiation 44 may be in a fixed position with respect to the build material platform 12. The source 34 in the fixed position may be a conductive heater or a radiative heater that is part of the printing system 10. These types of heaters may be placed below the build area platform 12 (e.g., conductive heating from below the platform 12) or may be placed above the build area platform 12 (e.g., radiative heating of the build material layer surface). In other examples, the source 34′ of radiation 44 may be positioned to apply radiation 44 to the build material composition 16 immediately after the fusing agent 26 has been applied thereto. In the example shown in FIG. 4, the source 34′ of radiation 44 is attached to the side of the applicator 24 which allows for patterning and heating/exposing to radiation 44 in a single pass.

The source 34, 34′ of radiation 44 may emit radiation 44 having wavelengths ranging from about 100 nm to about 1 mm. As one example, the radiation 44 may range from about 800 nm to about 2 μm. As another example, the radiation 44 may be blackbody radiation with a maximum intensity at a wavelength of about 1100 nm. The source 34, 34′ of radiation 44 may be infrared (IR) or near-infrared light sources, such as IR or near-IR curing lamps, IR or near-IR light emitting diodes (LED), or lasers with the desirable IR or near-IR electromagnetic wavelengths.

The source 34, 34′ of radiation 44 may be operatively connected to a lamp/laser driver, an input/output temperature controller, and temperature sensors, which are collectively shown as radiation system components 36. The radiation system components 36 may operate together to control the source 34, 34′ of radiation 44. The temperature recipe (e.g., radiation exposure rate) may be submitted to the input/output temperature controller. During heating, the temperature sensors may sense the temperature of the build material composition 16, and the temperature measurements may be transmitted to the input/output temperature controller. For example, a thermometer associated with the heated area can provide temperature feedback. The input/output temperature controller may adjust the source 34, 34′ of radiation 44 power set points based on any difference between the recipe and the real-time measurements. These power set points are sent to the lamp/laser drivers, which transmit appropriate lamp/laser voltages to the source 34, 34′ of radiation 44. This is one example of the radiation system components 36, and it is to be understood that other radiation source control systems may be used. For example, the controller 30 may be configured to control the source 34, 34′ of radiation 44.

Fusing Agents

In the examples of the method 200, 300 and the system 10 disclosed herein, and as mentioned above, a fusing agent 26 may be used. Examples of the fusing agent 26 are dispersions including a radiation absorber (i.e., an active material). The active material may be any infrared light absorbing colorant. In an example, the active material is a near-infrared light absorber. Any near-infrared colorants, e.g., those produced by Fabricolor, Eastman Kodak, BASF, or Yamamoto, may be used in the fusing agent 26. As one example, the fusing agent 26 may be a printing liquid formulation including carbon black as the active material. Examples of this printing liquid formulation are commercially known as CM997A, 516458, C18928, C93848, C93808, or the like, all of which are available from HP Inc. Other suitable active materials include near-infrared absorbing dyes or plasmonic resonance absorbers.

As another example, the fusing agent 26 may be a printing liquid formulation including near-infrared absorbing dyes as the active material. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

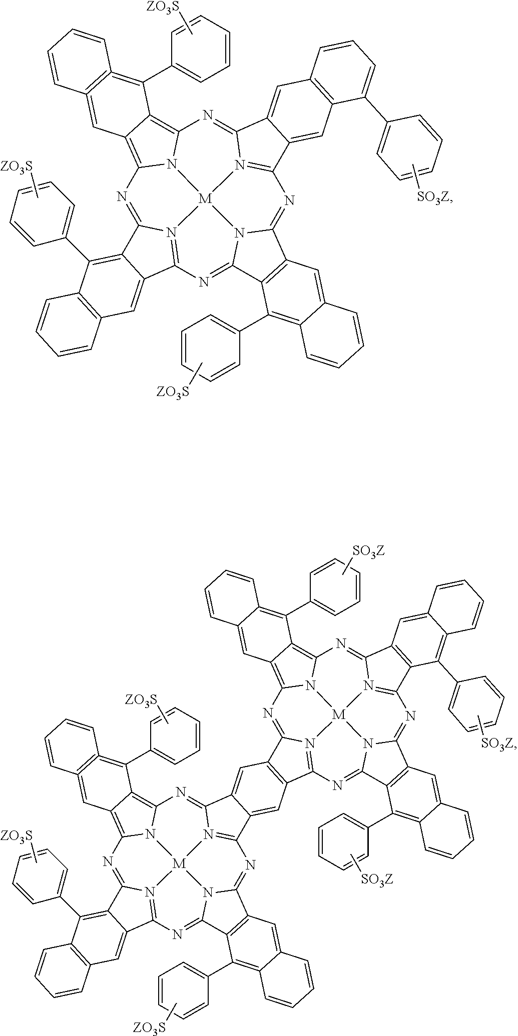

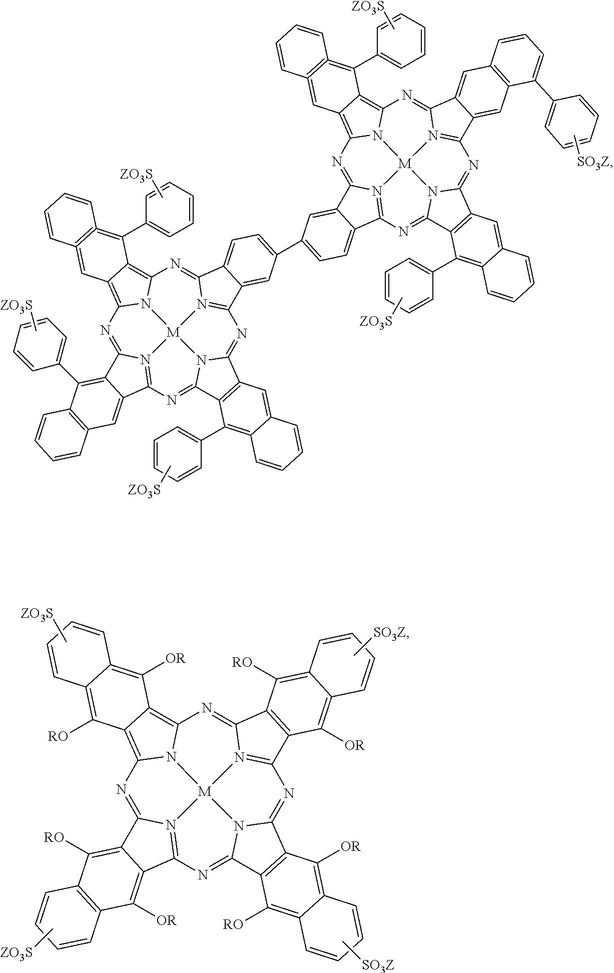

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

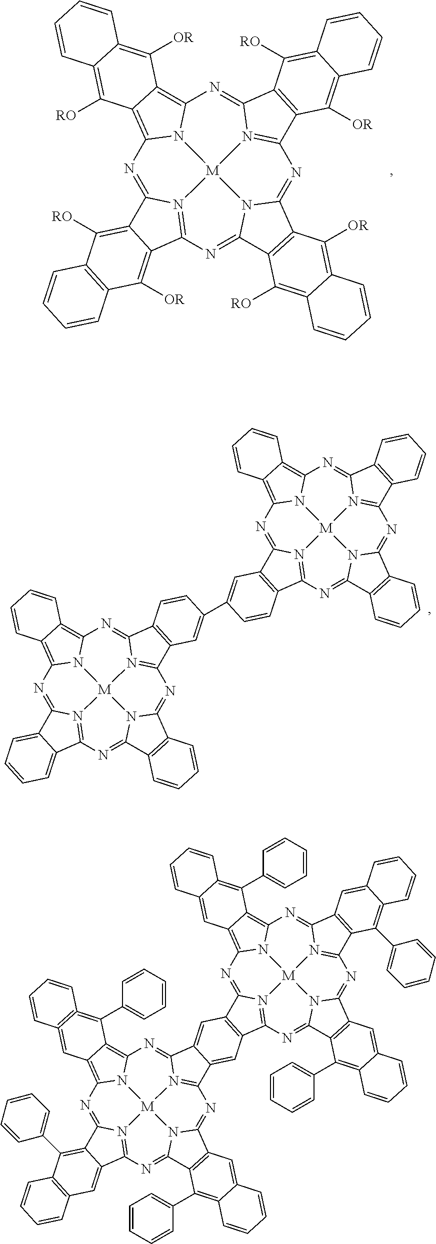

and mixtures thereof. For the hydrophobic near-infrared absorbing dyes, M can be a divalent metal atom (e.g., copper, etc.) or can include a metal that has Cl, Br, or OR′ (R′=H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthroquinone dyes or pigments and metal (e.g., nickel) dithiolene dyes or pigments may have the following structures, respectively:

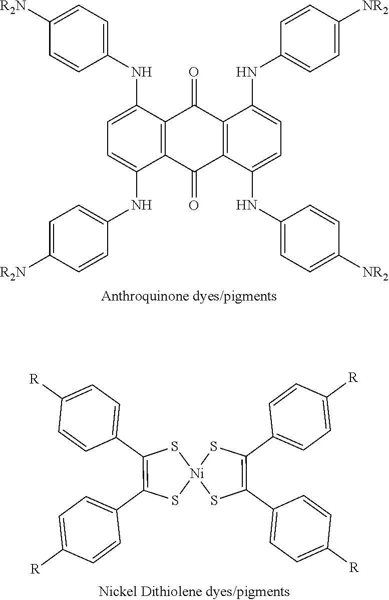

where R in the anthroquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

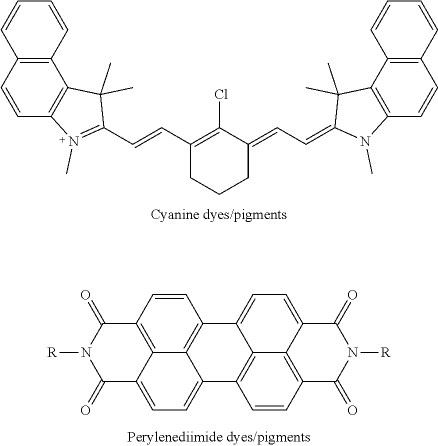

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

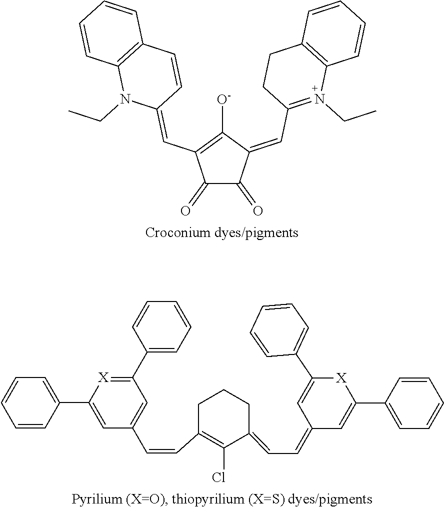

Boron-dipyrromethene dyes or pigments and aza-boron-dipyrromethene dyes or pigments may have the following structures, respectively:

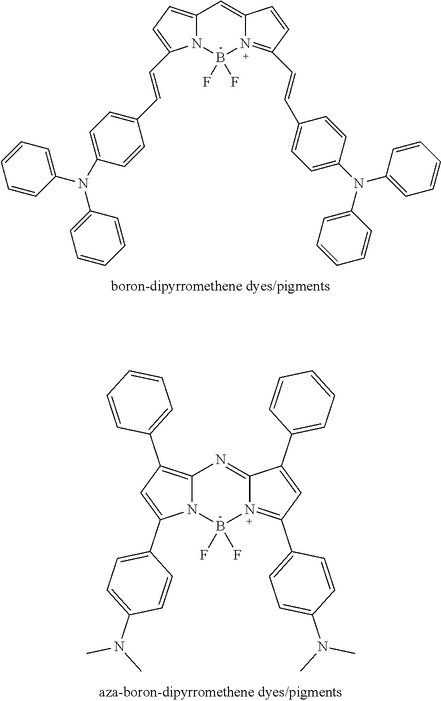

In other examples, the active material may be a plasmonic resonance absorber. The plasmonic resonance absorber allows the fusing agent 26 to absorb radiation at wavelengths ranging from 800 nm to 4000 nm (e.g., at least 80% of radiation having wavelengths ranging from 800 nm to 4000 nm is absorbed), which enables the fusing agent 26 to convert enough radiation to thermal energy so that the build material composition 16 fuses/coalesces. The plasmonic resonance absorber also allows the fusing agent 26 to have transparency at wavelengths ranging from 400 nm to 780 nm (e.g., 20% or less of radiation having wavelengths ranging from 400 nm to 780 nm is absorbed), which enables the 3D part to be white or slightly colored.

The absorption of the plasmonic resonance absorber is the result of the plasmonic resonance effects. Electrons associated with the atoms of the plasmonic resonance absorber may be collectively excited by radiation, which results in collective oscillation of the electrons. The wavelengths that can excite and oscillate these electrons collectively are dependent on the number of electrons present in the plasmonic resonance absorber particles, which in turn is dependent on the size of the plasmonic resonance absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the fusing agent 26 to be inkjet jettable as well as electromagnetically selective (e.g., having absorption at wavelengths ranging from 800 nm to 4000 nm and transparency at wavelengths ranging from 400 nm to 780 nm).

In an example, the plasmonic resonance absorber has an average particle diameter (e.g., volume-weighted mean diameter) ranging from greater than 0 nm to less than 220 nm. In another example the plasmonic resonance absorber has an average particle diameter ranging from greater than 0 nm to 120 nm. In a still another example, the plasmonic resonance absorber has an average particle diameter ranging from about 10 nm to about 200 nm.

In an example, the plasmonic resonance absorber is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the active material that is present in the fusing agent 26 ranges from greater than 0 wt % to about 40 wt % based on the total weight of the fusing agent 26. In other examples, the amount of the active material in the fusing agent 26 ranges from about 0.3 wt % to 30 wt %, from about 1 wt % to about 20 wt %, from about 1.0 wt % up to about 10.0 wt %, or from greater than 4.0 wt % up to about 15.0 wt %. It is believed that these active material loadings provide a balance between the fusing agent 26 having jetting reliability and heat and/or radiation absorbance efficiency.

As used herein, “FA vehicle” may refer to the liquid in which the active material is dispersed or dissolved to form the fusing agent 26. A wide variety of FA vehicles, including aqueous and non-aqueous vehicles, may be used in the fusing agent 26. In some examples, the FA vehicle may include water alone or a non-aqueous solvent alone with no other components. In other examples, the FA vehicle may include other components, depending, in part, upon the applicator 24 that is to be used to dispense the fusing agent 26. Examples of other suitable fusing agent components include dispersant(s), silane coupling agent(s), co-solvent(s), surfactant(s), antimicrobial agent(s), anti-kogation agent(s), and/or chelating agent(s).

When the active material is the plasmonic resonance absorber, the plasmonic resonance absorber may, in some instances, be dispersed with a dispersant. As such, the dispersant helps to uniformly distribute the plasmonic resonance absorber throughout the fusing agent 26. Examples of suitable dispersants include polymer or small molecule dispersants, charged groups attached to the plasmonic resonance absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the fusing agent 26 may range from about 10 wt % to about 200 wt % based on the weight of the plasmonic resonance absorber in the fusing agent 26.

When the active material is the plasmonic resonance absorber, a silane coupling agent may also be added to the fusing agent 26 to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the fusing agent 26 may range from about 0.1 wt % to about 50 wt % based on the weight of the plasmonic resonance absorber in the fusing agent 26. In an example, the total amount of silane coupling agent(s) in the fusing agent 26 ranges from about 1 wt % to about 30 wt % based on the weight of the plasmonic resonance absorber. In another example, the total amount of silane coupling agent(s) in the fusing agent 26 ranges from about 2.5 wt % to about 25 wt % based on the weight of the plasmonic resonance absorber.

The solvent of the fusing agent 26 may be water or a non-aqueous solvent (e.g., ethanol, acetone, n-methyl pyrrolidone, aliphatic hydrocarbons, etc.). In some examples, the fusing agent 26 consists of the active material and the solvent (without other components). In these examples, the solvent makes up the balance of the fusing agent 26.

Classes of organic co-solvents that may be used in a water-based fusing agent 26 include aliphatic alcohols, aromatic alcohols, diols, glycol ethers, polyglycol ethers, 2-pyrrolidones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Other examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the fusing agent 26 in a total amount ranging from about 1 wt % to about 50 wt % based upon the total weight of the fusing agent 26, depending upon the jetting architecture of the applicator 24. In an example, the total amount of the co-solvent(s) present in the fusing agent 26 is 25 wt % based on the total weight of the fusing agent 26.

The co-solvent(s) of the fusing agent 26 may depend, in part, upon the jetting technology that is to be used to dispense the fusing agent 26. For example, if thermal inkjet printheads are to be used, water and/or ethanol and/or other longer chain alcohols (e.g., pentanol) may be the solvent (i.e., makes up 35 wt % or more of the fusing agent 26) or co-solvents. For another example, if piezoelectric inkjet printheads are to be used, water may make up from about 25 wt % to about 30 wt % of the fusing agent 26, and the solvent (i.e., 35 wt % or more of the fusing agent 26) may be ethanol, isopropanol, acetone, etc. The co-solvent(s) of the fusing agent 26 may also depend, in part, upon the build material composition 16 that is being used with the fusing agent 26. For a hydrophobic powder (e.g., a polyamide), the FA vehicle may include a higher solvent content in order to improve the flow of the fusing agent 26 into the build material composition 16.

The FA vehicle may also include humectant(s). In an example, the total amount of the humectant(s) present in the fusing agent 26 ranges from about 3 wt % to about 10 wt %, based on the total weight of the fusing agent 26. An example of a suitable humectant is LIPONIC® EG-1 (i.e., LEG-1, glycereth-26, ethoxylated glycerol, available from Lipo Chemicals).

In some examples, the FA vehicle includes surfactant(s) to improve the jettability of the fusing agent 26. Examples of suitable surfactants include a self-emulsifiable, nonionic wetting agent based on acetylenic diol chemistry (e.g., SURFYNOL® SEF from Air Products and Chemicals, Inc.), a nonionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik). In some examples, it may be desirable to utilize a surfactant having a hydrophilic-lipophilic balance (HLB) less than 10.

Whether a single surfactant is used or a combination of surfactants is used, the total amount of surfactant(s) in the fusing agent 26 may range from about 0.01 wt % to about 10 wt % based on the total weight of the fusing agent 26. In an example, the total amount of surfactant(s) in the fusing agent 26 may be about 3 wt % based on the total weight of the fusing agent 26.

An anti-kogation agent may be included in the fusing agent 26 that is to be jetted using thermal inkjet printing. Kogation refers to the deposit of dried printing liquid (e.g., fusing agent 26) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3 A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the fusing agent 26 may range from greater than 0.20 wt % to about 0.65 wt % based on the total weight of the fusing agent 26. In an example, the oleth-3-phosphate is included in an amount ranging from about 0.20 wt % to about 0.60 wt %, and the low molecular weight polyacrylic acid polymer is included in an amount ranging from about 0.005 wt % to about 0.03 wt %.

The FA vehicle may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the fusing agent 26 may include a total amount of antimicrobial agents that ranges from about 0.05 wt % to about 1 wt %. In an example, the antimicrobial agent(s) is/are a biocide(s) and is/are present in the fusing agent 26 in an amount of about 0.25 wt % (based on the total weight of the fusing agent 26).

Chelating agents (or sequestering agents) may be included in the FA vehicle to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the fusing agent 26 may range from greater than 0 wt % to about 2 wt % based on the total weight of the fusing agent 26. In an example, the chelating agent(s) is/are present in the fusing agent 26 in an amount of about 0.04 wt % (based on the total weight of the fusing agent 26).

Detailing Agents

In the examples of the method 200, 300 and the system 10 disclosed herein, and as mentioned above, a detailing agent may be used. The detailing agent may include a surfactant, a co-solvent, and a balance of water. In some examples, the detailing agent consists of these components, and no other components. In some other examples, the detailing agent may further include a colorant. In still some other examples, detailing agent consists of a colorant, a surfactant, a co-solvent, and a balance of water, with no other components. In yet some other examples, the detailing agent may further include additional components, such as anti-kogation agent(s), antimicrobial agent(s), and/or chelating agent(s) (each of which is described above in reference to the fusing agent 26).

The surfactant(s) that may be used in the detailing agent include any of the surfactants listed above in reference to the fusing agent 26. The total amount of surfactant(s) in the detailing agent may range from about 0.10 wt % to about 5.00 wt % with respect to the total weight of the detailing agent.

The co-solvent(s) that may be used in the detailing agent include any of the co-solvents listed above in reference to the fusing agent 26. The total amount of co-solvent(s) in the detailing agent may range from about 1.00 wt % to about 20.00 wt % with respect to the total weight of the detailing agent.

Similar to the fusing agent 26, the co-solvent(s) of the detailing agent may depend, in part upon the jetting technology that is to be used to dispense the detailing agent. For example, if thermal inkjet printheads are to be used, water and/or ethanol and/or other longer chain alcohols (e.g., pentanol) may make up 35 wt % or more of the detailing agent. For another example, if piezoelectric inkjet printheads are to be used, water may make up from about 25 wt % to about 30 wt % of the detailing agent, and 35 wt % or more of the detailing agent may be ethanol, isopropanol, acetone, etc.

In some examples, the detailing agent does not include a colorant. In these examples, the detailing agent may be colorless. As used herein, “colorless,” means that the detailing agent is achromatic and does not include a colorant.

When the detailing agent includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye is also capable of absorbing radiation with wavelengths of 650 nm or less. As such, the dye absorbs at least some wavelengths within the visible spectrum, but absorbs little or no wavelengths within the near-infrared spectrum. This is in contrast to the active material in the fusing agent 26, which absorbs wavelengths within the near-infrared spectrum. As such, the colorant in the detailing agent will not substantially absorb the fusing radiation, and thus will not initiate melting and fusing of the build material composition 16 in contact therewith when the build material layer 38 is exposed to the fusing radiation.

The dye selected as the colorant in the detailing agent may also have a high diffusivity (i.e., it may penetrate into greater than 10 μm and up to 100 μm of the build material composition particles 16). The high diffusivity enables the dye to penetrate into the build material composition particles 16 upon which the detailing agent is applied, and also enables the dye to spread into portions of the build material composition 16 that are adjacent to the portions of the build material composition 16 upon which the detailing agent is applied. The dye penetrates deep into the build material composition 16 particles to dye/color the composition particles. When the detailing agent is applied at or just outside the edge boundary (of the final 3D part), the build material composition 16 particles at the edge boundary may be colored. In some examples, at least some of these dyed build material composition 16 particles may be present at the edge(s) or surface(s) of the formed 3D layer or part, which prevents or reduces any patterns (due to the different colors of the fusing agent 26 and the build material composition 16) from forming at the edge(s) or surface(s).

The dye in the detailing agent may be selected so that its color matches the color of the active material in the fusing agent 26. As examples, the dye may be any azo dye having sodium or potassium counter ion(s) or any diazo (i.e., double azo) dye having sodium or potassium counter ion(s), where the color of azo or dye azo dye matches the color of the fusing agent 26.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

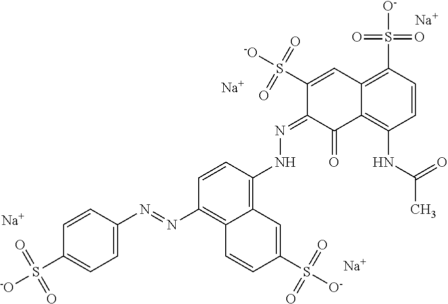

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

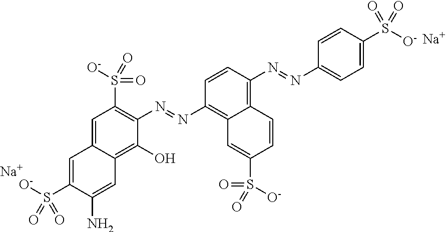 [SMILES: [Na+] ; Nc1cc2c(O)c(/N=N/c3ccc(/N=N/c4ccc(S(=O)(=O)[O-])cc4)c4ccc(S(=O)(=O)[O-])cc34)c(S(=O)(=O)[O-])cc2cc1S(=O)(=O)[O-] ; [Na+]]

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

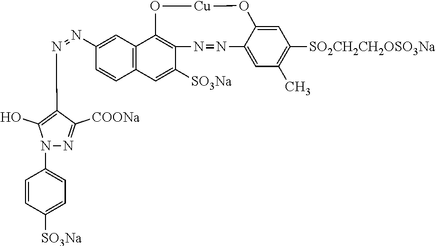

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

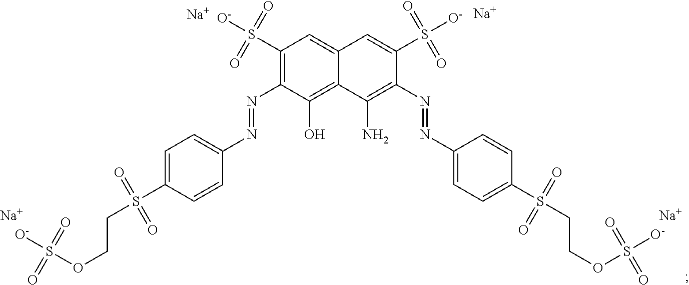 [SMILES: [Na+] ; Nc1c(/N=N/c2ccc(S(=O)(=O)CCOS(=O)(=O)[O-])cc2)c(S(=O)(=O)[O-])cc2cc(S(=O)(=O)[O-])c(/N=N/c3ccc(S(=O)(=O)CCOS(=O)(=O)[O-])cc3)c(O)c12 ; [Na+] ; [Na+] ; [Na+]]

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D part.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

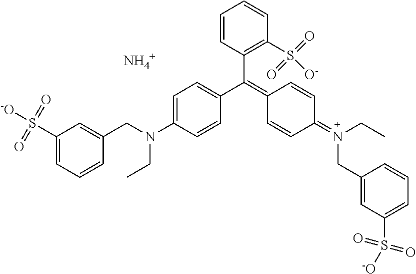

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

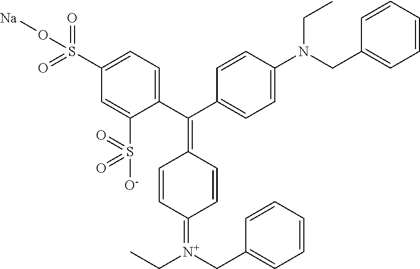

(commercially available as Acid Blue 7); and a phthalocyanine with a chemical structure of:

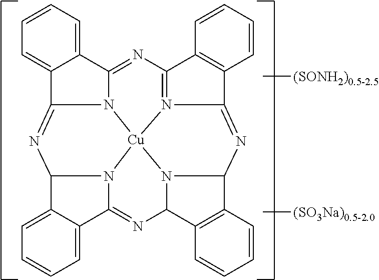

(commercially available as Direct Blue 199); and combinations thereof.

In an example of the detailing agent, the dye may be present in an amount ranging from about 1.00 wt % to about 3.00 wt % based on the total weight of the detailing agent. In another example of the detailing agent including a combination of dyes, one dye (e.g., the black dye) is present in an amount ranging from about 1.50 wt % to about 1.75 wt % based on the total weight of the detailing agent, and the other dye (e.g., the cyan dye) is present in an amount ranging from about 0.25 wt % to about 0.50 wt % based on the total weight of the detailing agent.

The balance of the detailing agent is water. As such, the amount of water may vary depending upon the amounts of the other components that are included.

Coloring Agents

In the examples of the method 200, 300 and the system 10 disclosed herein, and as mentioned above, a coloring agent may be used. The coloring agent may include a colorant, a surfactant, a co-solvent, and a balance of water. In some examples, the coloring agent consists of these components, and no other components. In some other examples, the coloring agent may further include additional components, such as dispersant(s), anti-kogation agent(s), antimicrobial agent(s), and/or chelating agent(s) (each of which is described above in reference to the fusing agent 26).

The coloring agent may be a black ink, a cyan ink, a magenta ink, or a yellow ink. As such, the colorant may be a black colorant, a cyan colorant, a magenta colorant, a yellow colorant, or a combination of colorants that together achieve a black, cyan, magenta, or yellow color.

In an example, the colorant may be present in the coloring agent in an amount ranging from about 0.1 wt % to about 10 wt % (based on the total weight of the coloring agent). In another example, the colorant may be present in the coloring agent in an amount ranging from about 0.5 wt % to about 5 wt % (based on the total weight of the coloring agent). In still another example, the colorant may be present in the coloring agent in an amount ranging from about 2 wt % to about 10 wt % (based on the total weight of the coloring agent).

In some examples, the colorant may be a dye. The dye may be non-ionic, cationic, anionic, or a combination thereof. Examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include Direct Black 154, Direct Black 168, Fast Black 2, Direct Black 171, Direct Black 19, Acid Black 1, Acid Black 191, Mobay Black SP, and Acid Black 2. The dye may also be any of the examples listed in reference to the detailing agent.

In other examples, the colorant may be a pigment. As used herein, “pigment” may generally include organic and/or inorganic pigment colorants that introduce color to the coloring agent and the 3D printed part. The pigment can be self-dispersed with a polymer, oligomer, or small molecule or can be dispersed with a separate dispersant (described above in reference to the fusing agent 26).

Examples of pigments that may be used include Paliogen® Orange, Heliogen® Blue L 6901F, Heliogen® Blue NBD 7010, Heliogen® Blue K 7090, Heliogen® Blue L 7101F, Paliogen® Blue L 6470, Heliogen® Green K 8683, and Heliogen® Green L 9140 (available from BASF Corp.). Examples of black pigments include Monarch® 1400, Monarch® 1300, Monarch® 1100, Monarch® 1000, Monarch® 900, Monarch® 880, Monarch® 800, and Monarch® 700 (available from Cabot Corp.). Other examples of pigments include Chromophtal® Yellow 3G, Chromophtal® Yellow GR, Chromophtal® Yellow 8G, Igrazin® Yellow SGT, Igralite® Rubine 4BL, Monastral® Magenta, Monastral® Scarlet, Monastral® Violet R, Monastral® Red B, and Monastral® Violet Maroon B (available from CIBA). Still other examples of pigments include Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4 (available from Evonik). Yet other examples of pigments include Tipure® R-101 (available from DuPont), Dalamar® Yellow YT-858-D and Heucophthal Blue G XBT-583D (available from Heubach). Yet other examples of pigments include Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B (available from Clariant). Yet other examples of pigments include Quindo® Magenta, Indofast® Brilliant Scarlet, Quindo® Red R6700, Quindo® Red R6713, and Indofast® Violet (available from Mobay). Yet other examples of pigments include L74-1357 Yellow, L75-1331 Yellow, and L75-2577 Yellow, LHD9303 Black (available from Sun Chemical). Yet other examples of pigments include Raven® 7000, Raven® 5750, Raven® 5250, Raven® 5000, and Raven® 3500 (available from Columbian).

When the coloring agent is applied at or just outside the edge boundary (of the final 3D part), the build material composition 16 at the edge boundary may be colored. In some examples, at least some of these dyed build material composition 16 particles may be present at the edge(s) or surface(s) of the formed 3D layer or part, which prevents or reduces any patterns (due to the different colors of the fusing agent 26 and the build material composition 16) from forming at the edge(s) or surface(s).

The surfactant(s) that may be used in the coloring agent include any of the surfactants listed above in reference to the fusing agent 26. The total amount of surfactant(s) in the coloring agent may range from about 0.01 wt % to about 20 wt % with respect to the total weight of the coloring agent. In an example, the total amount of surfactant(s) in the coloring agent may range from about 5 wt % to about 20 wt % with respect to the total weight of the coloring agent.

The co-solvent(s) that may be used in the coloring agent include any of the co-solvents listed above in reference to the fusing agent 26. The total amount of co-solvent(s) in the coloring agent may range from about 1 wt % to about 50 wt % with respect to the total weight of the coloring agent.

Similar to the fusing agent 26 and the detailing agent, the co-solvent(s) of the coloring agent may depend, in part upon the jetting technology that is to be used to dispense the coloring agent. For example, if thermal inkjet printheads are to be used, water and/or ethanol and/or other longer chain alcohols (e.g., pentanol) may make up 35 wt % or more of the coloring agent. For another example, if piezoelectric inkjet printheads are to be used, water may make up from about 25 wt % to about 30 wt % of the coloring agent, and 35 wt % or more of the coloring agent may be ethanol, isopropanol, acetone, etc.

The balance of the coloring agent is water. As such, the amount of water may vary depending upon the amounts of the other components that are included.

To further illustrate the present disclosure, examples are given herein. It is to be understood these examples are provided for illustrative purposes and are not to be construed as limiting the scope of the present disclosure.

### EXAMPLES

### Example 1

Two examples of the build material composition were prepared, and two comparative build material compositions were prepared. The example polymer build material used in each of the example build material compositions was a polyamide 12 with a starting solution viscosity (i.e., the solution viscosity before any aging process) of about 1.6 and a reactivity of about 31%. The comparative polymer build material used in each of the comparative build material compositions was a polyamide 12 with a starting solution viscosity (i.e., the solution viscosity before any aging process) of about 1.73 and a reactivity of less than 5%. Soda lime glass beads (SPHERIGLASS® A-Glass 3000 Solid Glass Microspheres from Potters Industries, LLC) that were not modified with any functional group were dry blended with each of the polymer build materials to form, respectively, the first example build material composition and the first comparative build material composition. Soda lime glass beads (SPHERIGLASS® A-Glass 3000 Solid Glass Microspheres from Potters Industries, LLC), modified with a functional silane recommend for use with polyam ides, were also dry blended with each of the polymer build materials to form, respectively, the second example build material composition and the second comparative build material composition. Each of the example build material compositions and each of the comparative build material compositions had a weight ratio of the glass beads to the polymer build material of about 40:60.

Several type V specimens (as specified by the ASTM D638 standard) were printed using each of the example build material compositions and each of the comparative build material compositions. Each specimen was printed on a small testbed 3D printer with an example fusing agent that included carbon black as the active material. Each specimen was allowed to cool in a room temperature environment upon completion of the build and was not heated after formation. The ultimate tensile strength, strain at break, and Young's Modulus were measured for each specimen according to the ASTM D638 standard using Instron testing equipment. Each specimen is identified by the build material composition used to form the specimen. The average values for each of these measurements are shown below in Table 1.

TABLE 1

| | Tensile | Strain | Young's |
|---|---|---|---|
| Build material | strength | at Break | Modulus |
| composition | (MPa) | (%) | (MPa) |
| First example build | 37.5 | 6.4 | 2625.1 |
| material composition | | | |
| Second example build | 40.1 | 6.0 | 2660.8 |
| material composition | | | |
| First comp. example | 30.1 | 8.3 | 2470.6 |
| build material | | | |
| composition | | | |
| Second comp. | 29.4 | 6.1 | 2616.9 |
| example build | | | |
| material composition | | | |

As shown in Table 1, the ultimate tensile strength of the specimens printed with the example build material compositions was increased compared to the specimens printed with the comparative build material compositions. As also shown in Table 1, the modification of the glass beads with the functional silane did not make a substantial difference in the ultimate tensile strength of the specimens. These results indicate that the improvement in the ultimate tensile strength of the specimens printed with the example build material compositions was due to the reactivity of the example polymer build material.

Injection molded, type V specimens were also formed using each of the example build material compositions and each of the comparative build material compositions. The ultimate tensile strength, strain at break, and Young's Modulus were measured for each specimen. While the results are not shown, each of the measured properties were marginally improved for the injection molded specimens formed from the example build material compositions compared to the injection molded specimens formed from the comparative build material compositions. These results indicate that while the improvement in the ultimate tensile strength of the specimens formed with the example build material compositions can be achieved in other 3D formation techniques, the improvement is more pronounced in the 3D parts that are 3D printed with a fusing agent.

### Example 2

An additional example of the build material composition (i.e., the third example build material composition) was prepared, and an additional comparative build material composition (i.e., the third comparative build material composition) was prepared. Borosilicate glass beads (SPHERIGLASS® E-Glass 3000E Solid Glass Microspheres from Potters Industries, LLC), that were modified with a functional silane recommend for use with polyamides, were encapsulated by the example polymer build material (described in Example 1) to form the third example build material composition. Soda lime glass beads (SPHERIGLASS® A-Glass 3000 Solid Glass Microspheres from Potters Industries, LLC) that were not modified with any functional group were encapsulated by comparative polymer build material (described in Example 1) to form the third comparative build material composition. Each of the third example build material composition and the third comparative build material composition had a weight ratio of the glass beads to the polymer build material of about 40:60.

Several type V specimens (as specified by the ASTM D638 standard) and type I specimens (as specified by the ASTM D638 standard) were printed using each of the third example build material composition and the third comparative build material composition (and the example fusing agent including carbon black). For each of the third example and comparative build material compositions, one type V specimen (labeled “A”) was printed using a small testbed 3D printer, and allowed to cool in a room temperature environment upon completion of the build. For each of the third example and comparative build material compositions, one type V specimen (labeled “B”) was printed using the small testbed 3D printer and then heated in an oven at 165° C. for about 22 hours. For each of the third example and comparative build material compositions, one type V specimen (labeled “C”) was printed on a large format 3D printer in an about 6.5 hour printing process. For the third comparative build material composition, one type V specimen (labeled “D”) was printed on the large format 3D printer in an about 13 hour printing process. A corresponding specimen was not prepared for the third build material composition. For the third example build material composition, one type I specimen (labeled “E”) was printed on the large format 3D printer in an about 6.5 hour printing process. A corresponding specimen was not prepared for the third comparative build material. For each of the third example and comparative build material compositions, one type I specimen (labeled “F”) was printed on the large format 3D printer in an about 6.5 hour printing process, and then heated in an oven at 165° C. for about 16.5 hours (to simulate a full build).

The ultimate tensile strength, strain at break, and Young's Modulus were measured for each specimen. The results of each of these measurements for the specimens printed with the third example build material composition are shown below in Table 2. The results of each of these measurements for the specimens printed with the third comparative build material composition are shown below in Table 3.

TABLE 2

| Specimens formed | Tensile | Strain at | Young's |
|---|---|---|---|
| with Third Example | strength | Break | Modulus |
| Build Material | (MPa) | (%) | (MPa) |
| A | 31 | 9 | 2698 |
| B | 37 | 7 | 2657 |
| C | 35 | 4 | 2729 |
| E | 31.4 | 6.6 | 2697.7 |
| F | 39.4 | 4 | 3062.8 |

TABLE 3

| Specimen formed | | | |
|---|---|---|---|
| with Third Comp. | Tensile | Strain at | Young's |
| Example Build | strength | Break | Modulus |
| Material | (MPa) | (%) | (MPa) |
| A | 28 | 30 | 2103 |
| B | 33 | 7 | 2335 |
| C | 28 | 16 | 2621 |
| D | 28 | 8 | 2252 |
| F | 29.5 | 5.4 | 2591.1 |

As shown in Tables 2 and 3, the ultimate tensile strength of the specimens printed with the third example build material composition was increased as compared to the specimens printed with the third comparative build material composition. As also shown in Table 2, heating the specimens at 165° C. for about 22 hours (specimen B) (as compared to allowing the specimen to cool in a room temperature environment upon completion of the build, specimen A) and heating the specimen at 165° C. for about 16 hours after the about 6.5 hour printing process (specimen F) (as compared to the about 6.5 hour printing process alone, specimen E), increased the ultimate tensile strength of the specimens printed with the third example build material composition. However, allowing the specimens to cool in a room temperature environment upon completion of the build (as compared to heating the specimens at 165° C. for about 22 hours) and the about 6.5 hour printing process alone (as compared to heating at 165° C. for about 16 after an about 6.5 hour printing process), resulted in a shorter printing process.

Also, the ultimate tensile strength values measured for the specimens printed with the second example build material (in Table 1) are comparable with the ultimate tensile strength values measured for the specimens printed with the third example build material (in Table 2). These results indicate that the type of the glass beads (i.e., soda lime glass or borosilicate glass) did not make a substantial difference in the ultimate tensile strength of the specimens, and the improvement in the ultimate tensile strength of the specimens printed with the example build material compositions was due to the reactivity of the example polymer build material.

Injection molded, type V specimens were also formed using each of the third example build material composition and the third comparative build material composition. The ultimate tensile strength, strain at break, and Young's Modulus were measured for each specimen. While the results are not shown, each of the measured properties were marginally improved for the injection molded specimens formed from the third example build material composition compared to the injection molded specimens formed from the third comparative build material composition. These results indicate that while the improvement in the ultimate tensile strength of the specimens formed with the third example build material composition can be achieved in other 3D formation techniques, the improvement is more pronounced in the 3D parts that are 3D printed with a fusing agent.

### Example 3

Another example of the build material composition (i.e., the fourth example build material composition) was prepared, and another comparative build material composition (i.e., the fourth comparative build material composition) was prepared. The example polymer build material used in the fourth example build material composition was a polyamide 12 with a starting solution viscosity (i.e., the solution viscosity before any aging process) of about 1.618 and a reactivity of about 9.53%. The comparative polymer build material used in the fourth comparative build material composition was a polyamide 12 with a starting solution viscosity (i.e., the solution viscosity before any aging process) of about 1.633 and a reactivity of about 0.86%. Soda lime glass beads (SPHERIGLASS® A-Glass 3000 Solid Glass Microspheres from Potters Industries, LLC) that were not modified with any functional group were dry blended with each of the polymer build materials to form, respectively, the fourth example build material composition and the fourth comparative build material composition.

Several type V specimens (as specified by the ASTM D638 standard) were printed using each of the first example build material composition (from Example 1), the fourth example build material composition, the first comparative build material composition (from Example 1), and the fourth comparative build material composition. About 8 specimens using the example build material composition were printed. Each specimen was printed on a small testbed 3D printer with an example fusing agent that included carbon black as the active material. Each specimen was allowed to cool in a room temperature environment upon completion of the build and was not heated after formation.

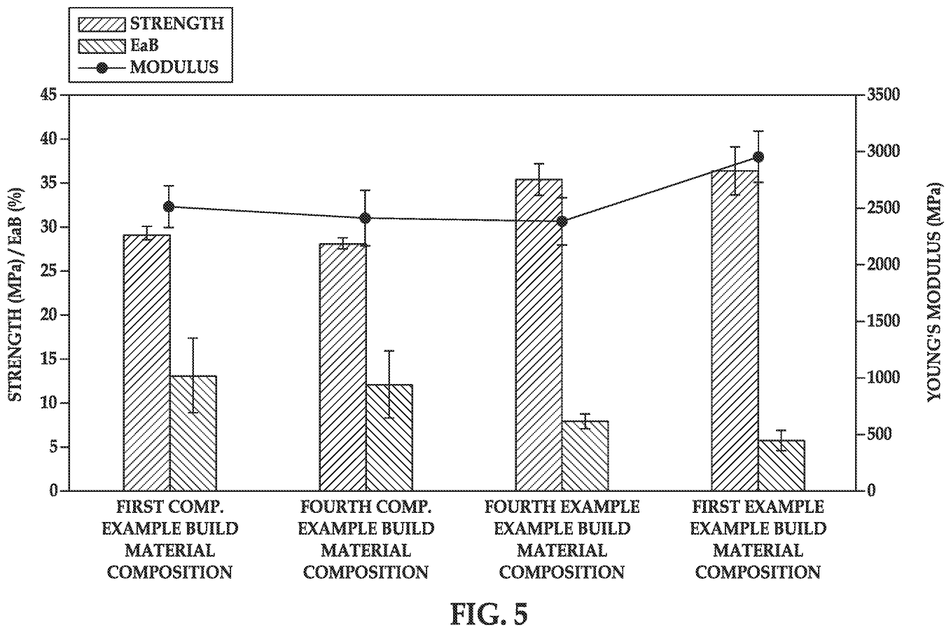

The ultimate tensile strength, strain at break, and Young's Modulus were measured for each specimen according to the ASTM D638 standard using Instron testing equipment. The average values for each of these measurements are shown in FIG. 5. In FIG. 5, the ultimate tensile strength (in MPa, left axis), the strain at break (or elongation at break (EaB) in %, left axis), and the Young's Modulus (in MPa, right axis) are shown on the y-axes. Each specimen is identified on the x-axis by the build material composition used to form the specimen in order (from left to right) of increasing reactivity of the polymer build material. As such, FIG. 5 shows that a higher reactivity of the polymer build material corresponds to a higher ultimate tensile strength of the specimen.

It is to be understood that the ranges provided herein include the stated range and any value or sub-range within the stated range. For example, a temperature ranging from about 120° C. to about 140° C. should be interpreted to include not only the explicitly recited limits from about 120° C. to about 140° C., but also to include individual values, such as about 122.5° C., about 136° C., about 138.7° C., etc., and sub-ranges, such as from about 121° C. to about 139° C., etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A build material composition for three-dimensional (3D) printing, comprising:
a polymer build material having a reactivity greater than 5%, wherein the polymer build material is selected from the group consisting of a polyamide, polybutylene terephthalate, polyethylene terephthalate, polyether block amide elastomers, and combinations thereof; and
glass.

2. The build material composition as defined in claim 1 wherein the reactivity of the polymer build material ranges from greater than 5% to 40%.

3. The build material composition as defined in claim 1 wherein the glass is dry blended with the polymer build material.

4. The build material composition as defined in claim 1 wherein the glass is encapsulated by the polymer build material.

5. The build material composition as defined in claim 1 wherein a weight ratio of the glass to the polymer build material ranges from about 5:95 to about 60:40.

6. The build material composition as defined in claim 1 wherein the glass is selected from the group consisting of solid glass beads, hollow glass beads, porous glass beads, glass fibers, crushed glass, and a combination thereof.

7. The build material composition as defined in claim 1 wherein:
the glass is selected from the group consisting of soda lime glass, borosilicate glass, phosphate glass, fused quartz, and a combination thereof; or
a surface of the glass is modified with a functional group selected from the group consisting of an acrylate functional silane, a methacrylate functional silane, an epoxy functional silane, an ester functional silane, an amino functional silane, and a combination thereof; or
a combination thereof.

8. The build material composition as defined in claim 1 wherein an average particle size of the build material composition ranges from about 5 μm to about 100 μm.

9. A kit for three-dimensional (3D) printing, comprising:
a build material composition including:
a polymer build material having a reactivity greater than 5%, wherein the polymer build material is selected from the group consisting of a polyamide, polybutylene terephthalate, polyethylene terephthalate, polyether block amide elastomers, and combinations thereof; and
glass; and
a fusing agent to be applied to at least a portion of the build material composition during 3D printing, the fusing agent including a radiation absorber to absorb radiation to melt or fuse the polymer build material in the at least the portion.

10. The kit as defined in claim 9 wherein a weight ratio of the glass to the polymer build material ranges from about 5:95 to about 60:40.

11. A method for three-dimensional (3D) printing, comprising:
applying a build material composition to form a build material layer, the build material composition including:
a polymer build material having a reactivity greater than 5%; and
glass;
based on a 3D object model, selectively applying a fusing agent on at least a portion of the build material composition; and
exposing the build material composition to radiation to fuse the at least the portion to form a layer of a 3D part.

12. The method as defined in claim 11, further comprising repeating the applying of the build material composition, the selectively applying of the fusing agent, and the exposing of the build material composition, wherein the repeating forms the 3D part including the layer.

13. The method as defined in claim 12 wherein the 3D part has an ultimate tensile strength greater than or equal to 35 MPa.

14. The method as defined in claim 12, further comprising:
upon completion of the 3D part, placing the 3D part in an environment having a temperature ranging from about 15° C. to 30° C.; and
maintaining the 3D part in the environment until a temperature of the 3D part reaches the temperature of the environment.

15. The method as defined in claim 12, further comprising heating the 3D part at a temperature ranging from greater than 30° C. to about 177° C. for a time period ranging from greater than 0 hours to about 144 hours.
